(19) United States
(12) Patent Application Publication
(10) Pub. No.: US 2021/0388219 A1
(43) Pub. Date: Dec. 16, 2021

(54) Conductive Primer Composition and Method for Preparing the Same

(71) Applicant: PPG Coatings (Tianjin) Co., Ltd., Tianjin (CN)

(72) Inventors: Feng Liu, Tianjin (CN); Junbo Xu, Tianjin (CN); Biao Deng, Tianjin (CN); Chunyan Zhou, Tianjin (CN); Jinqiang Wang, Tianjin (CN); Junzhen Fang, Tianjin (CN); Yan Zhang, Tianjin (CN); Zhigang Hu, Tianjin (CN)

(73) Assignee: PPG Coatings (Tianjin) Co., Ltd., Tianjin (CN)

(21) Appl. No.: 17/287,503

(22) PCT Filed: Oct. 22, 2019
(86) PCT No.: PCT/CN2019/112473

§ 371 Date: Apr. 21, 2021

(30) Foreign Application Priority Data
Oct. 22, 2018 (CN) 201811229302.0

(51) Int. Cl. C09D 5/24; C09D 5/00; C09D 133/00; C09D 7/61; C09D 7/40; C09D 7/20

(52) U.S. Cl. CPC C09D 5/24; C09D 5/002; C09D 7/20; C09D 7/61; C09D 7/70; C09D 133/00

(57) ABSTRACT

A conductive primer composition comprising: (a) a resinous component comprising: a chlorinated polyolefin resin, an acrylic resin, and a polyester resin; (b) conductive titanium dioxide; (c) a non-conductive pigmented filler; and (d) an organic solvent is disclosed. A method of preparing a conductive primer composition is also disclosed.

### FIELD OF INVENTION

The present invention relates to primer compositions, especially to conductive primer compositions for plastic substrates, and methods of preparing conductive primer compositions.

### BACKGROUND OF INVENTION

Automobile bumpers are commonly made by plastic substrates, such as, PP, ABS plastics, etc. For the automobile bumpers made by plastic substrates, common methods for spraying coatings comprise air pressure spraying and electrostatic spraying methods. However, when using the air pressure spraying method, the paint composition often tends to splash, resulting in poor painting ratio and waste of coating. In contrast, use of electrostatic spraying method can improve the painting ratio and reduce the amount of the coatings. Thus, the electrostatic spraying method has been more widely used in the recent years.

However, plastic substrates generally have high resistance, which is not favorable for electrostatic spraying. Therefore, there is a need of imparting conductivity to the surface of plastic substrates so as to reduce the resistance of substrate surface prior to electrostatic spraying. Hence, it is required to pre-coat the plastic substrate of automobile bumpers with a conductive primer coating.

Currently, primer coatings which are commonly used for plastic substrates of automobile bumpers are black or dark grey conductive primer coating compositions containing carbon black as conductive pigment. Such coatings behave well in terms of conductivity, covering power, adhesion, chemical resistance, impact resistance, and the like. However, due to the coating colors, these coatings have their considerable limitations for use in white or light-color automobiles. That is, it is usually required to use a thick basecoat layer having white or light color to cover the black color of the primer. This not only requires increased basecoat costs and is not favorable for environmental protection, but also tends to cause appearance problems, such as, lost gloss, pearlescence sinking, or the like. Therefore, there is a need to provide a white or light-color conductive primer composition for plastic substrates of automobile bumpers, which can not only significantly reduce the resistance of the surface of plastic substrates as conventional dark-color primer, but also satisfy the performance requirements of automobile primers including aesthetic property, covering power, adhesion, chemical resistance, and the like.

### SUMMARY OF INVENTION

The present invention provides a conductive primer composition comprising:

(a) a resinous component comprising: a chlorinated polyolefm resin, an acrylic resin and polyester resin, the chlorinated polyolefm resin, the acrylic resin, and the polyester resin being different from each other;

(b) conductive titanium dioxide;

(c) a non-conductive pigmented filler; and

(d) an organic solvent.

The present invention further provides a method of preparing a conductive primer composition comprising: (1) mixing a resinous component, a non-conductive pigmented filler, a solvent, and optionally additive(s), and grinding the resultant mixture to achieve a maximum particle size of 12.7 μm or below in the mixture; and (2) adding conductive titanium dioxide to the mixture obtained in (1), and conducting a high-speed dispersion at 1500-2000 rpm at room temperature for 15-30 minutes to achieve a maximum particle size of 12.7 μm or below in the mixture to which the conductive titanium dioxide is added.

### DETAILED DESCRIPTION

Unless used in the examples or clearly indicated otherwise, it is to be understood that all the values representing the amounts of components, reaction conditions, and the like used in the specification and claims may vary in accordance with the term “about” in all cases. Thus, unless otherwise indicated to be contrast, all the numerical parameters as listed in the following description and the accompanying claims are approximate values, and can vary in accordance with the properties to be desired in the present application. At the least, but not to limit the implementation of doctrine of equivalents of the claims, each and every numerical value should at least be interpreted in accordance with its valid number and applied to normal rounding.

Although the numerical ranges and parameters for listing broad ranges of the present invention are approximate values, the numerical records as listed in the examples should be as accurate as possible. However, any value inherently has a certain error. Such error is an inevitable result of the standard deviation resulted from the corresponding measurement method.

The present invention provides a conductive primer composition comprising: (a) a resinous component comprising: a chlorinated polyolefm resin, an acrylic resin, and a polyester resin; (b) conductive titanium dioxide; (c) a non-conductive pigmented filler; and (d) an organic solvent. The conductive primer composition of the present invention can be used for plastic substrates, such as, pumbers.

The conductive primer composition of the present invention can be one-component (“1K”). As used herein, the term “one-component” means that all the film-forming materials, the pigmented filler, the solvent, and the adjuvants of the primer composition are packed in a single container, and thus results in advantages including eases of storage and use, etc.

The conductive primer composition of the present invention can be non-crosslinking, that is, the primer composition is free of a crosslinker, no crosslinking reaction takes place in the resin, and the primer composition is self-dried to form a film.

As used herein, the term “conductive” means that when applied to a plastic substrate (such as, PP, ABS), the primer composition can significantly reduce the surface resistance of the plastic substrate, thereby facilitating the subsequent electrostatic spraying of a basecoat. In accordance with the conductive primer composition of the present invention, when applied onto a plastic substrate, the dry film resistance of the coating is less than 700 kΩ, and the 6-minute flash-dry resistance is less than 650 kΩ, as measured in accordance with a touch method. In some embodiments, both the dry film resistance and the 6-minute flash-dry resistance of the coating layer formed on the plastic substrate by use of the conductive primer composition of the present invention are less than 350 kΩ.

The conductive primer composition of the present invention exhibits a white or light color (such as, silvery, grey, yellow, and the like). As used herein, the term “white” means that when applied onto a plastic substrate (such as, PP, ABS), the coating layer formed by the primer composition has a brightness (45° L value) of 80 or above, in accordance with the L*a*b color system as defined by JIS Z 8729.

### Chlorinated Polyolefm Resin

As used herein, the term “chlorinated polyolefm resin” refers to those prepared from the chlorination of polyolefms. The chlorinated polyolefm can be thermoplastic. The thermoplastic resins are characterized by softening by heating and hardening by cooling, and do not require a chemical reaction with a crosslinker during formation of a coating layer. Typically, the thermoplastic resins have a larger molecular weight and a lower hydroxyl value as compared with thermoset resins.

Since the chlorinated polyolefm resins and PP plastic substrates have great structural similarity, there is good compatibility between them due to the mechanism of “like dissolves like”. Thus, the present invention utilizes the chlorinated polyolefm resin as one component of the resin composition to improve the adhesion between the primer composition of the present invention and the pumber substrate (such as, PP, ABS). Commonly used chlorinated polyolefm resins are primarily classified into unmodified chlorinated polypropylene resins, acrylic acid-modified chlorinated polypropylene resins, and maleic acid-modified chlorinated polypropylene resins. Unmodified chlorinated polypropylene resins are cheap, but have disadvantages like poor compability with other types of resins, poor storage stability, and poor wettability to pigmented filler. Thus, they are rarely used as the coating for automobile pumbers and/or parts. By contrast, acrylate-or maleate-modifided chlorinated polypropylene resins overcome the disadvantages including poor compability with other types of resins, poor storage stability, and poor wettability to pigmented filler, exhibit good interlayer adhesition, and thus are for use in automobile coatings.

The chlorinated polyolefm resin used in the present invention comprises an acrylic acid-modified chlorinated polypropylene resins and a maleic acid-modified chlorinated polypropylene resins, suitably a maleic acid-modified chlorinated polypropylene resins. The chlorinated polyolefm resin used in the present invention may be a maleic acid-modified chlorinate polypropylene resin having a chlorine content of 20-30 wt %, a weight average molecular weight (Mw) of 50,000-100,000, and a maleic anhydride grafting ratio (weight ratio of maleic anhydride to ungrafted chlorinated polypropylene resin) of 1-2 wt %, wherein the weight average molecular weight (Mw) is determined by a gel permeation chromatography using an appropriate standard such as a polystyrene standard.

Examples of suitable chlorinated polyolefm resins for use in the present invention comprise, but are not limited to, HARDLEN F-2P from Toyobo Co., LTD; SUPERCHLON 921S and SUPERCHLON 822S from Nippon Paper Chemicals So., LTD; and CP 730-1 20% IN AROMATIC from Eastman Chemical Company.

In the conductive primer composition in accordance with the present invention, the chlorinated polyolefm resin can be present in amounts of at least 20 wt %, suitably at least 25 wt %, such as, at least 28 wt %, and at most 45 wt %, such as, at most 40 wt %, even at most 35 wt %, based on the total solid weight of the resinous component.

### Acrylic Resin

As used herein, the term “acrylic resin” refers to a polymer, copolymer or a mixture of polymers derived from acrylic acid- or methacrylic acid-based monomers. Moreover, the acrylic resin can further be a copolymer, a mixed polymer or a mixture of polymers derived from acrylic acid- or methacrylic acid-based monomers with other polymerizable monomers. The acrylic resin used in the present invention is thermoplastic. The thermoplastic acrylic resin can repeatedly undergo softening by heating and solidification by cooling, and no further crosslinking will occur during the formation of film. It has advantages including good gloss and color retention, low temperature stability, water and chemical resistance, and the like. The acrylic resin used in the present invention is suitably a chlorinated polypropylene-modified acrylic resin. By addition of the chlorinated polypropylene-modified acrylic resin, the adhesion of the primer composition to PP substrates can be improved, and as a result the amount of the chlorinated polyolefm resin can be correspondingly decreased, thereby reducing the cost while further improving the compability between resins in the system, the storage stability and the wettability to the pigmented filler.

The chlorinated polypropylene in the chlorinated polypropylene-modified acrylic resin for use in the present invention may have a grafting ratio (weight ratio of chlorinated polypropylene to ungrafted acrylic resin) of 10-25 wt %, a hydroxyl value of less than 100 mgKOH/g, and an acid value of less than 40 mgKOH/g. The acrylic resin may also have a hydroxyl value of less than 35 mgKOH/g, and an acid value of less than 2 mgKOH/g. Also, a mixture of acrylic resins having different hydroxyl values and acid values may be employed, for example, a mixture of an acrylic resin having an acid value of less than 2 mgKOH/g and a hydroxyl value of less than 35 mgKOH/g and an acrylic resin having an acid value of 30-40 mgKOH/g and a hydroxyl value of 70-100 mgKOH/g.

Examples of suitable acrylic resins for use in the present invention comprise, but are not limited to, AKLATE ACL-1000 and AKLATE ACL-400 from Aekyung Chemical; and OLIO C629 from Zhejiang UVChem Special Coatings.

In accordance with the conductive primer composition of the present invention, the acrylic resin may be present in amounts of at least 30 wt %, suitably at least 35 wt %, such as, at least 40 wt %, and at most 70 wt %, such as, at most 60 wt %, and even at most 55 wt %, based on the total solid weight of the resinous components.

### Polyester Resin

The polyester resin is made by condensation polymerization between polyol(s) and polyacid(s), wherein the polyol(s) refer to compounds having two or more hydroxyl groups in each molecule, and the polyacid(s) refer to compounds having two or more carboxyl groups in each molecule. The polyester resin for use in the the present invention is thermoplastic. The polyester resins can repeatedly undergo softening by heating and solidification by cooling; having advantages of good dispersibility, high universality, and the like; and can improve the adhesion between the the primer composition and the basecoat layer.

The polyester resin for use in the present invention may have an acid value of 4-6 mgKOH/g. Examples of suitable polyester resins for use in the present invention comprise, but are not limited to, SETAL 173 VS-60 and SETAL 189 from Nuplex.

In accordance with the conductive primer composition of the present invention, the thermoplastic polyester resin comprise at least 5 wt %, suitably at least 10 wt %, such as, at least 15 wt %, and at most 40 wt %, e.g., at most 30 wt %, and even at most 25 wt %, based on the total solid weight of the resinous components.

### Conductive Titanium Dioxide

Conductive titanium dioxide is a white pigment having conductive function, which may be made from titanium dioxide powders as basis material by allowing the titanium dioxide powders to undergo surface treatment so as to form a conductive oxide layer on the surface of the basic material. The conductive titanium dioxide has advantages like good gloss, whiteness, covering power, and the like, and thus can be used in conductive coatings with higher whiteness requirement. The conductive titanium dioxide for use in the present invention can have flake-like, needle-like, fiber-like shapes or the like, suitably flake- or needle-like shape, and most suitably flake-like shape.

The conductive titanium dioxide for use in the present invention may have TiO₂ as basis material, and comprise Sb doped SnO₂ as surface material. The conductive titanium dioxide may have a resistivity of about 2 to 60 Ω·cm, which can be measured by a commercial resistivity tester. The conductive titanium dioxide may have a specific surface area of about 25-35 m²/g, and an oil absorption rate of 50-80 g/100 g.

Examples of suitable conductive titanium dioxides for use in the present invention comprise, but are not limited to, DENTALL WK-500 from DKSH North America, FT-3000 and ECT-100G from ISHIHARA SANGYO KAISHA, LTD, as well as HCT-200 from Changzhou Nano-Materials S&T.

In accordance with the conductive primer composition of the present invention, the conductive titanium dioxide may be present in amounts of at least 50 parts by weight, suitably at least 60 parts by weight, such as, 65 parts by weight, and at most 150 parts by weight, such as, at most 120 parts by weight, even at most 100 parts by weight, based on 100 parts by weight of the total solid weight of the resin component.

### Non-Conductive Pigmented Filler

The non-conductive pigmented filler for use in the present invention can exhibit white or light colors (such as, silvery, grey, yellow, and the like). White pigmented fillers commonly used in coatings primarily comprise titanium dioxide powders, fumed silica, bentonite, and barium sulfate. The non-conductive white pigmented filler for use in the present invention can be titanium dioxide powders. Examples of non-conductive white pigmented fillers for use in the present invention comprise, but are not limited to, TI-PURE RUTILE R900-PQ28 from Dupont, R-900-39 TI02 and R-706 TI-PURE TITANIUM DIOXIDE from The Chemours Company LLC.

In accordance with the conductive primer composition of the present invention, the non-conductive pigmented filler can be at least 50 parts by weight, suitably at least 70 parts by weight, such as, 80 parts by weight, and at most 160 parts by weight, such as, 130 parts by weight, even at most 100 parts by weight, based on 100 parts by weight of the total solid weight of the resin component.

### Organic Solvent

The organic solvent for use in the present invention comprises one or more of hydrocarbon-based solvents, ester-based solvents, ether-based solvents, and alcohol-based solvents, suitably hydrocarbon-based solvents and/or ester-based solvents, most suitably a mixture of a hydrocarbon-based solvent and an ester-based solvent. The hydrocarbon-based solvent is primarily used for dissolving the chlorinated polyolefm resin. The ester-based solvent is primarily used for dissolving the acrylic resin and polyester resin. Examples of suitable hydrocarbon-based solvents for use in the present invention comprise, but are not limited to, toluene, mixtures of ethylbenzene and xylene, naphtha and the like. Examples of suitable ester-based solvents for use in the present invention comprise, but are not limited to, methyl acetate, ethyl acetate, n-propyl acetate, and the like. The organic solvent for use in present invention is suitably a mixture of a hydrocarbon-based solvent and an ester-based solvent with a mass ratio of the hydrocarbon-based solvent to the ester-based solvent of 1:3 to 3:1, suitably 1:2 to 2:1.

In accordance with the conductive primer composition of the present invention, the organic solvent is present in amounts of at least 250 parts by weight, suitably at least 300 parts by weight, such as, at least 320 parts by weight, and at most 450 parts by weight, such as, 400 parts by weight, even at most 360 parts by weight, based on 100 parts by weight of the total solid weight of the resin component.

The conductive primer composition in accordance with the present invention can further comprise one or more additives comprising, but being not limited to: dispersants, such as, DISPERBYK-110 and DISPERBYK-161 from BYK Additives and Instruments; levelling agents, such as, BYK-306 from BYK Additives and Instruments; anti-settling waxes, such as, M-P-A 2000X from Elementis Specialties and DISPARLON NS-5501 from Kusumoto Chemicals, LTD; fillers; and the like. The types and amounts of these additives can be determined by persons skilled in the art in accordance with the desired properties of the primer composition.

The present invention further provides a method of preparing a conductive primer composition comprising: (1) mixing a resinous component, a non-conductive pigmented filler, a solvent and optionally additive(s), and grinding the resultant mixture to achieve a maximum particle size of 12.7 μm or below in the mixture; and (2) adding conductive titanium dioxide into the mixture obtained in (1), and conducting a high-speed dispersion at 1500-2000 rpm at room temperature for 15-30 minutes so as to achieve a maximum particle size of 12.7 μm or below in the mixture to which the conductive titanium dioxide is added; wherein the resinous component comprises a chlorinated polyolefm resin, an acrylic resin, and a polyester resin, the chlorinated polyolefm resin, the acrylic resin, and the polyester resin being different from each other. The particle size of a mixture can be measured by a commercial scraper fineness gauge.

Since the pigment or the filler as added tends to aggregrate in the primer composition, it is required to reduce the fineness of the primer mixture to be 12.7 μm or below by a grinding technology so as to satisfy the industrial requirements. However, during grinding, the conductive surface layer of the conductive titanium dioxide is likely to damage due to collision or friction with grinding beads (such as, steel beads, zirconium bead, or the like). Thus, the grinding technology reduces the fineness with increasing the resistance, and it renders the resistance of the primer coating uncontrollable. For achieving the desired resistance of primer, it is required to add an excess of conductive titanium dioxide to offset the resistance increase generated during grinding. The high-speed dispersion technology avoids to a large extent the corrosion/friction between the conductive titanium dioxide particles, and reduces the damage of the conductive surface layer of the conductive titanium dioxide, thereby keeping the conductivity of the conductive titanium dioxide as much as possible without causing the actual resistance of the finished coating to deviate significantly from the theoretically calculated value or rendering the resistance of the primer coating uncontrollable. The method of preparing the conductive primer composition in accordance with the present invention utilizes a combination of the grinding technology with the high-speed dispersion technology (i.e., grinding first the resinous component, the pigmented filler, the additive(s) and the like, and then adding the conductive pigment, followed by high-speed dispersion), so that the primer composition achieves a maximum particle size of 12.7 μm or below, while the conductive surface layer of the conductive titanium dioxide would not be damaged during the high-speed dispersion. As a result, it can control the resistance of the primer coating, and reduces the amount of the conductive titanium dioxide, thus saves the cost. The high-speed dispersion technology for use in the present invention may be achieved by high-speed rotation of jagged impeller. The rotation speed can be 1500-2000 rpm, and the dispersion time can be 15-30 minutes. By comparison, for achieving the same resistance of the primer coatings, the preparation method of the present invention requires an amount of conductive titanium dioxide which is 11-13 wt % less than that of the prior art preparation method utilizing the grinding technology alone.

### EXAMPLE

The following examples are provided for further illustrating the present invention, but not considered to limit the present invention to the details as described in the examples. Unless otherwise indicated, all the parts and percentages in the following examples are based on weight.

The conductive primer compositions of the present invention were prepared in accordance with the components and amounts as shown in Table 1 below.

TABLE 1
The conductive primer compositions of the present invention

| Components | Ex. 1 | Ex. 2 | Ex. 3 |
|---|---|---|---|
| Chloride polyolefin | 4.2^{a1} | 3.8^{a2} | 4.4^{a3} |
| Acrylic resin | 6.3^{b1} | 7.2^{b2} | 7.9^{b3} |
| Polyester resin | 3.3^{c1} | 3.8^{c2} | 2.8^{c1} |
| Conductive titanium dioxide ^{d} | 15 | 20 | 13 |
| Common titanium white^{e} | 17 | 12 | 20 |
| Hydrocarbon-based solvent | 32 | 32 | 32 |
| Ester-based solvent | 17.8 | 16.8 | 16.5 |
| Dispersant^{f} | 1 | 1 | 1 |
| Levelling agent^{g} | 0.2 | 0.2 | 0.2 |
| Anti-settling wax^{h} | 0.5 | 0.5 | 0.5 |

^{a1}HARDLEN F-2P, supplied by Toyobo Co., LTD;
^{a2}CP 730-1 20% IN AROMATICT, supplied by Eastman Chemical Company;
^{a3}SUPERCHLON 921S, supplied by Nippon Paper Chemicals So., LTD;
^{b1}AKLATE ACL-1000, supplied by Aekyung Chemical;
^{b2}AKLATE ACL-400, supplied by Aekyung Chemical;
^{b3}OLIO C629, supplied by Zhejiang UVChem Special Coatings;
^{c1}SETAL 173 VS-60, supplied by Nuplex;
^{c2}SETAL 189, supplied by Nuplex;
^{d} DENTALL WK-500, supplied by DKSH North America;
^{e}TI-PURE RUTILE R900-PQ28, supplied by Dupont;
^{f}DISPERBYK-110, supplied by BYK Additives and Instruments;
^{g}BYK-306, supplied by BYK Additives and Instruments;
^{h}M-P-A 2000X, supplied by Elementis Specialities.

The primer compositions of the foresaid Examples 1, 2, and 3 were applied onto PP substrates, and the formed coatings were subjected to the following performance tests. The obtained results are shown in Table 2, and the coatings formed by the conductive primers in accordance with the present invention are compared with the prior art products for their performances.

### Performance Indexes

1. Resistance: In the present invention, the coating was tested by a touch method using Ransburg Resistance Tester for its dry film resistance and flash-dried resistance. The dry film resistance is a value measured by drying the primer coating composition on the substrate to form a film, and then contacting the positive and the negative probes of the resistance tester with the surface of the coating film, until the reading of the instrument settles. The dry film resistance is the resistance which can be actually achieved by the conductive titanium dioxide in the coating.

The 6-minute flash-dry resistance is the resistance of the coating which has underwent a 6-minute short flash-drying and film-forming (pre-baking). Due to the short flash-drying time, the solvent cannot be sufficiently volatilized, and the touch is easy to damage the coating film. As a result, the flash-dry resistance tends to be higher than the dry film resistance. In the actual operation, the primer would not be baked after application, and thus the flash-dry resistance is closer to the actual situation.

2. Covering Film Thickness: It is an index for measuring the covering power of a primer for a substrate. The covering film thickness as described in the present invention is a film thickness when the primer completely covers a black-and-white grid paper.

3. 45° L Value: The L value of the L*a*b color system as defined in accordance with JIS Z 8729 represents the whiteness of a coating. The larger the L value, the whiter the coating.

TABLE 2
Performance Indexes of coatings formed by the conductive
primer compositions in accordance with Examples 1, 2,
and 3 of the present invention on plastic substrate

| Performance indexes | Ex. 1 | Ex. 2 | Ex. 3 |
|---|---|---|---|
| Dry film resistance | 700 kΩ | 600 kΩ | 320 kΩ |
| 6-minute flash-dry | 550 kΩ | 460 kΩ | 340 kΩ |
| resistance | | | |
| Covering film | 25 | 25 | 28 |
| thickness | | | |
| 45° L value | 86 | 88 | 86 |

It can be seen from Table 2 that the coatings formed by the conductive primers of the present invention have 6-minute flash-dry resistance of less than 650 kΩ, or even less than 350 kΩ, which are significantly better than the currently commercially available products (typically, 2-30 MΩ). Moreover, the covering film thickness and the L value of the conductive primers of the present invention also satisfy the industrial performance requirements of white primers for automobiles. In brief, the coating layer formed by the conductive primer of the present invention has low resistance, good covering power, high whiteness, and can satisfy the industrial requirements for automobile primers, such as, adhesion, chemical resistance, impact resistance, and the like.

Although the particular aspects of the present invention have been explained and described, it is apparent for persons skilled in the art that many other variations or modifications can be made without departing the spirit and scope of the present invention. Thus, the accompanying claims are intended to encompass all the variations and modifications falling within the scope of the present invention.

1. A conductive primer composition comprising:
(a) a resinous component comprising: a chlorinated polyolefm resin, an acrylic resin, and a polyester resin, the chlorinated polyolefm resin, the acrylic resin, and the polyester resin being different from each other;
(b) conductive titanium dioxide;
(c) a non-conductive pigmented filler; and
(d) an organic solvent.

2. The primer composition of claim 1, wherein the composition is one-component.

3. The primer composition of any of the preceding claims, wherein the composition is non-crosslinking.

4. The primer composition of any of the preceding claims, wherein the chlorinated polyolefm resin is a maleic acid-modified chlorinated polypropylene resin having a chlorine content of 20-30 wt %.

5. The primer composition of any of the preceding claims, wherein the resinous component comprises 20-45 wt % chlorinated polyolefm resin based on the total solid weight of the resinous component.

6. The primer composition of any of the preceding claims, wherein the acrylic resin is a chlorinated polypropylene-modified acrylic resin.

7. The primer composition of any of the preceding claims, wherein the conductive titanium dioxide is present in amounts of 50 to 150 parts by weight, based on 100 parts by weight of the solids of the resinous component.

8. The primer composition of any of the preceding claims, wherein the non-conductive white pigmented filler is present in amounts of 50-160 parts by weight, based on 100 parts by weight of the solids of the resinous component.

9. The primer composition of any of the preceding claims, wherein the conductive titanium dioxide has a flake-like and/or needle-like shape.

10. The primer composition of any of the preceding claims, wherein the non-conductive pigmented filler comprises one or more selected from the group consisting of: titanium dioxide powder, fumed silica, bentonite, and barium sulfate.

11. The primer composition of any of the preceding claims, wherein the organic solvent comprises one or more of a hydrocarbon-based solvent and an ester-based solvent.

12. The primer composition of any of the preceding claims, wherein a coating layer formed by the primer composition on a plastic substrate has a 6-minute flash-dry resistance of less than 650 kΩ.

13. A method of preparing a conductive primer composition comprising:
(1) mixing a resinous component, a non-conductive pigmented filler, a solvent, and optically additive(s), and grinding the resultant mixture to achieve a maximum particle size of 12.7 μm or below in the mixture; and
(2) adding conductive titanium dioxide to the mixture obtained in (1), and conducting a high-speed dispersion at 1500-2000 rpm at room temperature for 15-30 minutes, to achieve a maximum particle size of 12.7 μm or below in the mixture to which the conductive titanium dioxide is added.

14. The Method of claim 13, wherein the resinous component comprises a chlorinated polyolefm resin, an acrylic resin, and a polyester resin, the chlorinated polyolefm resin, the acrylic resin, and the polyester resin being different from each other.
